(19) United States
(12) Patent Application Publication
(10) Pub. No.: US 2012/0173433 A1
(43) Pub. Date: Jul. 5, 2012

(54) METHOD AND SYSTEM FOR PROVIDING FINANCIAL SERVICE

(75) Inventors: Jae-Min PARK, Seoul (KR); Myoung-Hee SEO, Seoul (KR); Yong-Ki MIN, Seoul (KR)

(73) Assignee: KT CORPORATION, Seongnam-si (KR)

(21) Appl. No.: 13/336,816

(22) Filed: Dec. 23, 2011

(30) Foreign Application Priority Data
Dec. 31, 2010 (KR) 10-2010-0140603

(51) Int. Cl. G06Q 20/40

(52) U.S. Cl. 705/67; 705/71

(57) ABSTRACT

A system and a method for providing a financial service. The system for providing a financial service can include: a first user terminal which signs financial transaction information with a pre-stored first private key, the financial transaction information including withdrawal account information, a PIN of the withdrawal account, deposit account information and amount information; a second user terminal which receives the signed financial transaction information by being connecting with the first user terminal through near field communication and which further signs the signed financial transaction information with a pre-stored second private key; and a financial server configured to transfer an amount corresponding to the amount information from an account of the withdrawal account information to an account of the deposit account information.

### CROSS-REFERENCE TO RELATED APPLICATIONS

This application claims the benefit of priority from the Korean Patent Application No. 10-2010-0140603, filed with the Korean Intellectual Property Office on Dec. 31, 2010, the disclosure of which is incorporated herein by reference in its entirety.

### BACKGROUND

1. Technical Field

Method and system consistent with exemplary embodiments relate to a financial service, and more specifically, to a method and a system for providing a financial service that can allow a secure financial transaction among user terminals by using an Near Field Communication (NFC)-based technology.

2. Background Art

In order to have a financial transaction, such as check available balance, deposit, withdrawal and transfer funds, through the conventional automated teller machines (ATM) or cash dispensers (CD) that are prepared by financial institutions, users have had to carry plastic cards, such as credit cards or ATM cards, insert the plastic card in the ATM or CD, select the desired transaction type and enter a PIN (personal identification number).

With the advancement of information technologies, there has been a steady increase of financial transactions using user terminals, such as mobile communication terminals, which have telecommunication functions, and there recently has been an increase of financial transactions using credit card information or bank account information stored in an IC chip that is installed in the user terminal.

Accordingly, there has been an increased demand for security associated with the financial transactions using the user terminal.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a method and a system for providing a financial service that can minimize network traffic by minimizing connection with financial institutions and allowing a financial transaction between user terminals.

One or more exemplary embodiments also provide a method and a system for providing a financial service that can enhance security by requiring each user terminal engaged in financial transactions to sign using a certificate and can prevent each user terminal from denying financial transactions.

An aspect of an exemplary embodiment provides a system that can perform a safe financial transaction between user terminals by using an NFC-based technology.

A system of performing a financial transaction in accordance with an exemplary embodiment can include: a first user terminal which signs financial transaction information with a pre-stored first private key. The financial transaction information may include withdrawal account information, a PIN of withdrawal account, deposit account information and amount information. The system further may include: a second user terminal which receives the signed financial transaction information by connecting to the first user terminal through near field communication and which further signs the signed financial transaction information with a pre-stored second private key; and a financial server which transfers an amount corresponding to the amount information from an account of the withdrawal account information to an account of the deposit account information.

Another exemplary aspect provides a system of providing a financial service by allowing a plurality of user terminals to be connected to a financial server.

A method of providing a financial service in accordance with an exemplary embodiment can include: extracting by the first user terminal account information from a first smart card installed in a first user terminal and outputting by the first user terminal the extracted account information as withdrawal account information; obtaining by the first user terminal deposit account information from a second smart card installed in a second user terminal using near field communication; receiving by the first terminal amount information and a PIN of withdrawal account; generating by the first user terminal financial transaction information including the withdrawal account information, the PIN of withdrawal account, the deposit account information and the amount information, signing by the first user terminal the generated financial transaction information with a first private key, and sending by the first user terminal the signed financial transaction information to the second user terminal; further signing by the second user terminal the signed financial transaction information with a second private key and sending by the second user terminal the double signed financial transaction information to the financial server; and verifying by the financial server the double signed financial transaction information with a public key and if the double signed financial transaction information is verified as valid, transferring by the financial server an amount corresponding to the amount information from an account of the withdrawal account information to an account of the deposit account information.

### BRIEF DESCRIPTION OF THE DRAWINGS

FIG. 1 is a block diagram illustrating a financial transaction system for financial transaction between NFC terminals according to an exemplary embodiment.

FIG. 2 is a block diagram illustrating an internal configuration of a user terminal for a financial transaction according to an exemplary embodiment.

FIG. 3 is a flow diagram illustrating a method for providing financial transaction in the financial transaction system according to an exemplary embodiment.

FIG. 4 is a view illustrating financial transaction using user terminals according to an exemplary embodiment.

### DETAILED DESCRIPTION

Since there can be a variety of permutations and embodiments, certain exemplary embodiments will be illustrated and described with reference to the accompanying drawings. This, however, is by no means to restrict the present invention to certain embodiments, and shall be construed as including all permutations, equivalents and substitutes covered by the ideas and scope of the present invention. Throughout the description of exemplary embodiments, when describing a certain technology is determined to evade the point of an inventive concept, the pertinent detailed description will be omitted.

Terms such as “first” and “second” can be used in describing various elements, but the above elements shall not be restricted to the above terms. The above terms are used only to distinguish one element from the other.

The terms used in the description are intended to describe certain embodiments only, and shall by no means restrict the present invention. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain exemplary embodiments will be described with reference to the accompanying drawings.

In an exemplary embodiments, the term “unit” is used to illustrate software, hardware or a combination of software and hardware. For example, a transfer processing unit may be a processor and a storage unit may be a memory. On the other hand, an extraction unit may be a software application which includes a number of executable instructions.

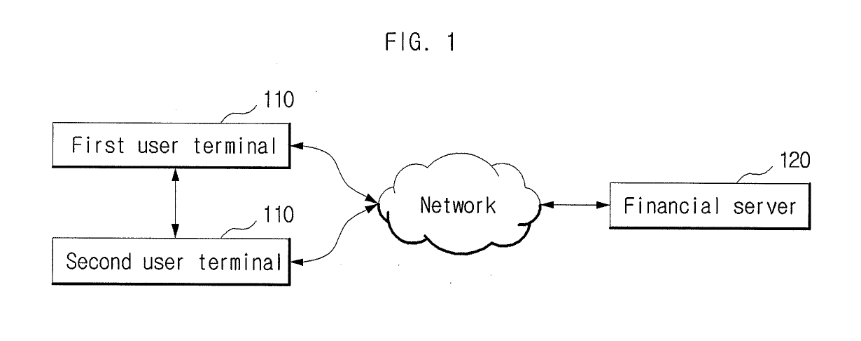

FIG. 1 is a block diagram illustrating a financial transaction system for financial transaction between NFC terminals according to an exemplary embodiment.

Referring to FIG. 1, the financial transaction system is configured by including a plurality of user terminals 110 and a financial server 120.

Each of the user terminals 110 is installed with a smart card, in which an account information (e.g., account number) and a certificate for financial transaction are stored. The certificate consists of a private key and a public key that are in pair. As the structure of a certificate is well known to those who are skilled in the art to which the exemplary embodiment pertains, and thus the detailed description thereof will be omitted hererin.

The user terminal 110 has an NFC (Near Field Communication) unit embedded therein, and financial transaction information can be communicated between the user terminals that are directly connected to the NFC unit.

That is, each of the user terminals 110 can send and receive the financial transaction information and can carry out financial transaction by sending a final financial transaction approval request to the financial server 120. This will be described in more detail later by referring to the relevant drawing.

The financial server 120 renews financial information of users (i.e. a sender and a recipient) corresponding to the user terminals 110 according to the financial transaction approval request from each of the user terminals 110, and provides an approval response pursuant to the renewal of the financial information to each of the user terminals 110.

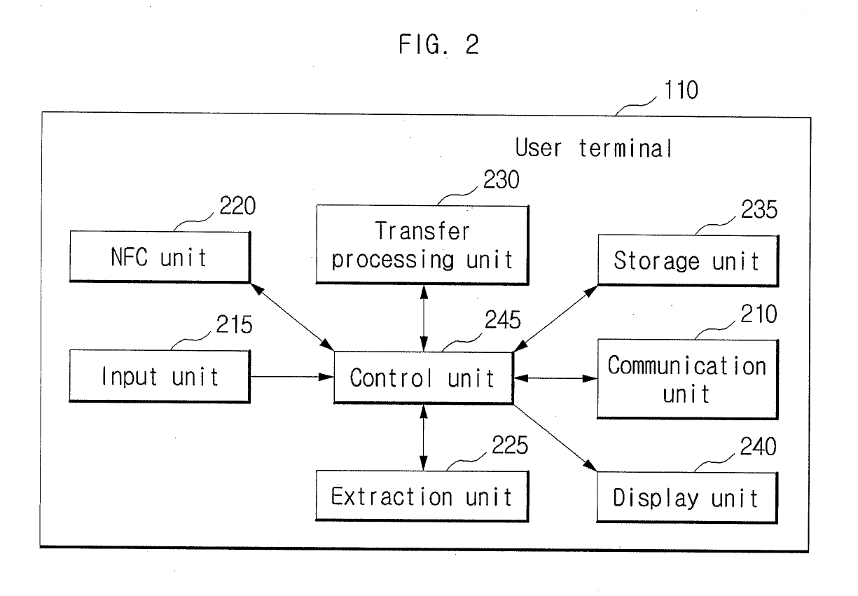

FIG. 2 is a block diagram illustrating an internal configuration of a user terminal for financial transaction according to an exemplary embodiment. Although not illustrated in FIG. 2, the user terminal 110 is embedded with a smart card, in which account information of a user is stored.

Referring to FIG. 2, the user terminal 110 is configured by including a communication unit 210, an input unit 215, an NFC unit 220, an extraction unit 225, a transfer processing unit 230, a storage unit 235, a display unit 240 and a control unit 245.

The communication unit 210 carries out a function of communicating data with other devices (e.g., the financial server 120) through a communication network.

The input unit 215 receives as input a control command for controlling the operation of the user terminal 110, a control command for operating an application and certain information. For example, the input unit 215 can be realized in the form of a plurality of key buttons (e.g., alphanumeric keys, * or # keys and one or more function keys, such as a menu key, a call key, an enter key, a run application key, etc.) or a touch screen.

The input unit 215 can receive numeric information input such as account PIN information, etc. Moreover, the input unit 215 can be used to select one of at least one account number transmitted from another user terminal 110 through the NFC unit 220.

The NFC unit 220 is a unit which provides data communication using short-range wireless technologies that operate at 13.56 MHz. The NFC unit 220 can be attached to the smart card or to the user terminal 110. The NFC unit 220 includes a tag mode and a reader mode. It is possible for the NFC unit 220 to perform near field communication with other devices that have an NFC unit embedded therein.

How near field communication is made when the NFC unit 220 is approached by another terminal is well known to those who are skilled in the art, and thus the detailed description thereof will be omitted herein.

The extraction unit 225 extracts account information from the smart card installed in the user terminal 110 when a financial transaction application is executed, and outputs withdrawal account information to the transfer processing unit 230.

The transfer processing unit 230 generates at least one of withdrawal account information, withdrawal account PIN, deposit account information and amount information as the financial transaction information. Then, the transfer processing unit 230 signs (i.e., encrypts) the generated financial transaction information with the pre-stored private key (e.g., the certificate) and sends the signed financial transaction information to another terminal to request the transfer to be processed.

The storage unit 235 stores various applications for operating the user terminal 110. Moreover, the storage unit 235 can store financial transaction records.

The display unit 240 is a means for outputting information inputted through the input unit 215 under the control of the control unit 245 and information provided from another terminal or the financial server 120 as visual information. For example, the display unit 240 can be a liquid crystal display (LCD).

The control unit 245 is a unit controlling internal elements (e.g., the communication unit 210, the input unit 215, the NFC unit 220, the extraction unit 225, the transfer processing unit 230, the storage unit 235 and the display unit 240) of the user terminal 110 for financial transaction between user terminals using the NFC-based technology.

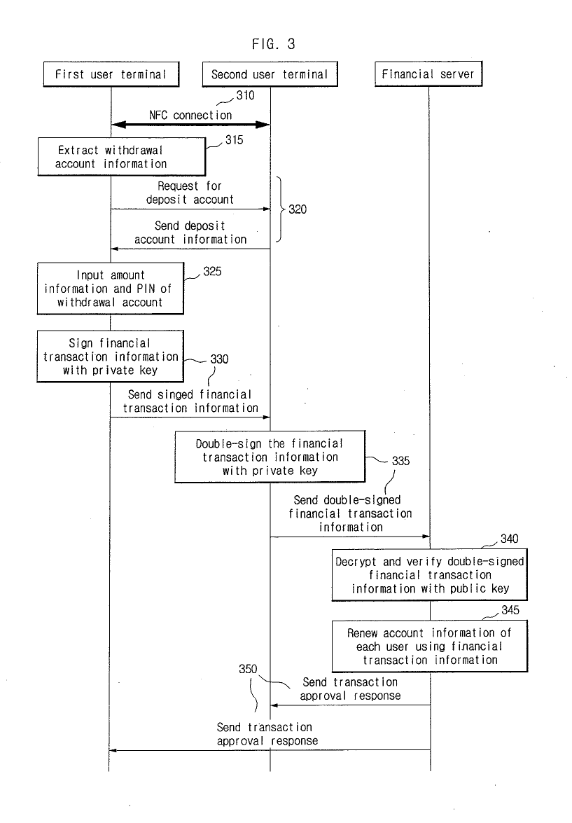

FIG. 3 is a flow diagram illustrating a method for providing financial transaction in the financial transaction system according to an exemplary embodiment.

In operation 310, the first user terminal searches for a second user terminal in close proximity through the NFC unit, is inputted with designated connection information from the user, and makes a connection for direct communication with the second user terminal. Here, the connection information can be PIN set by the second user terminal for performing near field communication with the second user terminal.

Accordingly, once the designated connection information is inputted through the first user terminal, the second user terminal makes the near field communication with the first terminal. If the designated connection information is erroneously input, the second user terminal can send an error message about the near field communication with the first user terminal to the first user terminal.

Once the first user terminal makes the near field communication with the second user terminal, the first user terminal can execute an application for financial transaction to carry out financial transaction, which will be described later. It shall be appreciated that the operations described hereinafter are carried out through the executed application for financial transaction.

In other words, the first user terminal is selected with the second user terminal that will carry out the financial transaction through the financial transaction application to perform the operations that followed. Here, since the first user terminal has input the connection information designated by the second user terminal for near field communication, the second user terminal can be authenticated using the connection information.

In operation 315, the first user terminal extracts account information from the installed smart card and can output the extracted account information as withdrawal account information on a screen of the first user terminal. Here, as described above, the withdrawal account information can include at least one of bank identification information and account information.

Then in operation 320, the first user terminal requests the second user terminal for deposit account information and obtains the deposit account information through the NFC unit.

According to the request of the first user terminal for the deposit account information, the second user terminal can extract the account information from the smart card and send the extracted account information as the deposit account information to the first user terminal.

In another example, if there are a plurality of deposit accounts in the deposit account information obtained through the NFC unit, the first user terminal can send an account selection request message to the second user terminal. Accordingly, the second user terminal can be selected with one of the plurality of deposit accounts according to the account selection request message and have the selected deposit account sent to the first user terminal.

As such, the deposit account information can be selected through the first user terminal, which is the subject of remittance, and it is also possible that the deposit account information is selected through the second user terminal, which is the subject of deposit.

In operation 325, the first user terminal is provided with a PIN of the withdrawal account and amount information for remittance from the user.

In operation 330, the first user terminal encrypts (i.e., signs) the withdrawal account information, a PIN of the withdrawal account, the deposit account information and the amount information as the financial transaction information by using the pre-stored private key and sends the signed financial transaction information to the second user terminal in operation 330. For easy description and understanding, the private key of the first user terminal will be referred to as a first private key hereinafter. Here, the private key can be a certificate provided by a certificate authority.

Accordingly, in operation 335, the second user terminal receives the encrypted financial transaction information, double-encrypts (i.e., signs) the received financial transaction information by using a pre-stored private key (i.e., a second private key), and sends the double-encrypted financial transaction information to the financial server in operation 335.

In operation 340, the financial server decrypts the double-encrypted financial transaction information by using the public key and verifies the financial transaction information.

Then in operation 345, if the financial transaction information is verified to be valid, the financial server carries out financial transaction according to the financial transaction information. That is, the financial server can transfer the amount corresponding to the amount information from an account corresponding to the withdrawal account information to an account corresponding to the deposit account information.

That is, the withdrawal account information can be renewed by subtracting the amount information from a balance of the withdrawal account information, and the deposit account information can be renewed by adding the amount information to a balance of the deposit account information.

Then in operation 350, the financial server sends results of the financial transaction to the first user terminal and the second user terminal, respectively.

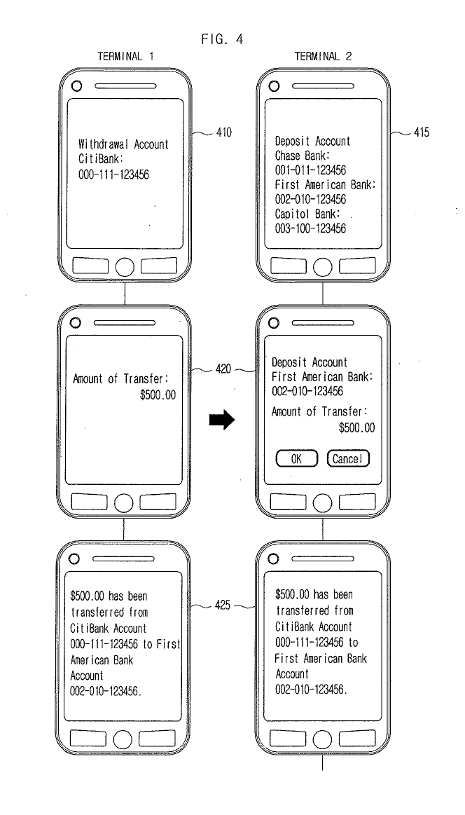

FIG. 4 is a view illustrating financial transaction using the user terminals according to an exemplary embodiment.

In FIG. 4, reference numeral 410 shows an example of the first user terminal having extracted the withdrawal account information stored in the smart card and displaying the withdrawal account information on the screen thereof. It is of course possible that a plurality of account information is stored in the smart card of the first user terminal, in which case the first user terminal can extract and display all account information stored in the smart card as the withdrawal account information and allow the user to select one.

Moreover, in case the account information is stored by corresponding to each financial transaction application, the first user terminal can only extract the account information corresponding to an executed financial transaction application as the withdrawal account information. Here, if there are a plurality of account information corresponding to the financial transaction application, one of the plurality of account information corresponding to the financial transaction application can be selected by the user, and the first user terminal can display the selected account information as the withdrawal account information on the screen thereof, as shown in reference numeral 410 of FIG. 4.

Once the withdrawal account information is extracted, the first user terminal can read the smart card installed in the second user terminal through the NFC unit and obtain the account information, and can output the obtained account information as the deposit account information on the screen of the first user terminal. Here, as illustrated in reference numeral 415 of FIG. 4, if there are a plurality of account information, one account information can be selected as the deposit account information by the user in the first user terminal. It is also possible that the first user terminal requests the second user terminal to select one of the plurality of account information and obtains the selected single account information.

Then, once the amount information is inputted by the user, the first user terminal can send the amount information and the deposit account information to the second user terminal and request verification, as illustrated in reference numeral 420 in FIG. 4. Here, the second user terminal can be provided with the amount information and the deposit account information and display the amount information and the deposit account information on a screen thereof and send a transaction approval message to the first user terminal once “OK” is selected by the user. However, if “Cancel” is selected by the user, the second user terminal can send a transaction cancellation message to the first user terminal.

Once the transaction approval message is received from the second user terminal, the first user terminal can encrypt (i.e., sign) the financial transaction information, including the withdrawal account information, the PIN of the withdrawal account, the deposit account information and the amount information, with the private key (i.e. certificate) and request the second user terminal for financial transaction. Accordingly, as described earlier, the second user terminal can double-encrypt (i.e., double-sign) the encrypted financial transaction information with the pre-stored private key (i.e., certificate) and request the financial server 120 for financial transaction.

Once the financial transaction is properly carried out by the financial server 120, financial transaction result messages can be generated and sent to the first user terminal and the second user terminal, as illustrated in reference numeral 425 of FIG. 4.

Accordingly, the first user terminal and the second user terminal can output the result of financial transaction, including the withdrawal account information, the deposit account information and the amount information, on the screen thereof.

The exemplary method for providing a financial service in the financial transaction system including the plurality of user terminals and the financial server in accordance with an exemplary embodiment can be embodied in the form of program instructions, which can be performed through various electronic data processing means, and can be written in a storage medium, which can include program instructions, data files, data structures and the combination thereof.

The program instructions stored in the storage medium can be designed and configured specifically for the exemplary embodiment or can be publically known and available to those who are skilled in the field of software. Examples of the storage medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above exemplary hardware devices can be configured to operate as one or more software modules in order to perform the operation in an exemplary embodiment, and the opposite is also possible.

Although exemplary embodiments have been described above, it shall be appreciated that there can be a variety of permutations and modifications by those who are ordinarily skilled in the art to which the inventive concept pertains without departing from the technical ideas and scope of the present invention, which shall be defined by the appended claims and their equivalents. Exemplary embodiments are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A system for executing a financial transaction, comprising:
a first user terminal which signs financial transaction information with a pre-stored first private key, the financial transaction information comprising withdrawal account information, a PIN of withdrawal account, deposit account information, and amount information;
a second user terminal which receives the signed financial transaction information from the first user terminal, where the second user terminal is connected to the first user terminal via near field communication, and which signs the signed financial transaction information with a pre-stored second private key; and
a financial server which transfers an amount indicated in the amount information from an account of the withdrawal account information to an account of the deposit account information.

2. The system of claim 1, wherein the first private key and the second private key are private keys included in a certificate provided by a certificate authority.

3. The system of claim 1, wherein each of the first user terminal and the second user terminal is installed with a smart card, and
wherein the smart card has the withdrawal account information or the deposit account information stored therein.

4. The system of claim 3, wherein the first user terminal comprises:
an NFC module configured to obtain the deposit account information from the smart card of the second user terminal;
an extraction unit configured to extract the withdrawal account information from the smart card according to execution of a financial transaction application;
an input unit configured to receives input of the withdrawal account information and the amount information; and
a transfer processing unit which signs the withdrawal account information, the PIN of withdrawal account, the deposit account information, and the amount information as the financial transaction information with the first private key and which requests the financial transaction.

5. The system of claim 4, wherein if a plurality of accounts in the deposit account information exists, the transfer processing unit requests the second user terminal to select one account in the deposit account information.

6. The system of claim 1, wherein the financial server generates a message according to a result of transfer and sends the message to the first user terminal and the second user terminal.

7. A method of providing a financial service by having a plurality of user terminals connected to a financial server, the method comprising:
extracting by a first user terminal account information from a first smart card installed in the first user terminal and outputting by the first user terminal the extracted account information as withdrawal account information;
obtaining by the first user terminal deposit account information from a second smart card installed in a second user terminal using near field communication;
receiving by the first user terminal amount information and a PIN of withdrawal account;
generating by the first terminal financial transaction information including the withdrawal account information, the PIN of the withdrawal account, the deposit account information and the amount information;
signing by the first terminal the generated financial transaction information with a first private key;
sending by the first terminal the signed financial transaction information to the second user terminal;
signing by the second terminal the signed financial transaction information with a second private key;
sending by the second terminal the double signed financial transaction information to the financial server; and
verifying by the financial server the double signed financial transaction information using a public key; and
if the double signed financial transaction information is verified as valid, transferring by the financial server an amount corresponding to the amount information from an account of the withdrawal account information to an account of the deposit account information.

8. The method of claim 7, further comprising, prior to the extracting of the account information:
requesting by the first user terminal a connection to the second user terminal by using near field communication;
inputting and sending by the first user terminal pre-designated connection information to the second user terminal; and
if the connection information is identical to a preset PIN, the second user terminal authorizes the connection of the first user terminal using near field communication.

9. The method of claim 7, wherein if a plurality of accounts in the deposit account information exists, the obtaining the deposit account information comprises, requesting the second user terminal to select one of the plurality of accounts and obtaining the selected one account from the deposit account information.

10. The method of claim 7, further comprising, after the transferring generating a result message according to the transferring and transmitting the result message to the first user terminal and the second user terminal.

11. A user terminal comprising:
an NFC module which obtains a deposit account information from a second smart card of a second user terminal via near field communication (NFC) with the second terminal;
an extraction unit which extracts withdrawal account information from the first smart card of the user terminal via an executed financial transaction application;
an input unit which receives input comprising a withdrawal account information and an amount information; and
a transfer processing unit which signs the withdrawal account information, a PIN of withdrawal account, a deposit account information, and the amount information as a financial transaction information with a first private key and which further requests the financial transaction,
wherein a financial server executes the financial transaction by transferring an amount indicated in the amount information from an account of the withdrawal account information to an account of the deposit account information and reports results to the user terminal.
